(19) United States
(12) Patent Application Publication
(10) Pub. No.: US 2005/0263196 A1
(43) Pub. Date: Dec. 1, 2005

(54) Air intake structure for electromagnetic valve assembly of a massage chair

(75) Inventor: Wen Hsu Hsieh, Changhua County (TW)

Correspondence Address: CHARLES E. BAXLEY, ESQ., 90 JOHN STREET, THIRD FLOOR, NEW YORK, NY, 10038, US

(73) Assignee: Kuang Yu Metal Working Co., Ltd.

(21) Appl. No.: 11/136,659

(22) Filed: May 23, 2005

(30) Foreign Application Priority Data
May 25, 2004 (TW) 093208140

(51) Int. Cl. F17D 1/00

(52) U.S. Cl. 137/883

(57) ABSTRACT

An air intake structure of an electromagnetic valve assembly for a massage chair comprising a plurality of electromagnetic valves, on each of the electromagnetic valve are defined air connecting portions, an air guide base is made of elastic material and is defined at an end thereof with a blind air feeding hole, in the air feeding hole are laterally defined passages for insertion of the air connecting portions of the respective electromagnetic valves, the air feeding hole is connected with an air intake duct assembly that is connected to an air source for introducing air into the air guide base.

### BACKGROUND OF THE INVENTION

1. Field of the Invention

The present invention relates to an air intake structure of an electromagnetic valve assembly, and more particularly to an air intake structure of an electromagnetic valve assembly for a massage chair.

2. Description of the Prior Arts

Nowadays, people are living in a stressful and busy society and usually feel tired and blue. Therefore, in order to maintain in a good mood, most of people would like to have their stress relaxed by doing exercise or massage. Massage chair is just one of the effective tools that provide a good relaxing effect, and the massage chair is generally provided with a plurality of airbags for massaging the back, the limbs or other parts of a user.

Referring to FIG. 1, a conventional electromagnetic valve assembly 10 for controlling an inflation and deflation of the airbags of a massage chair is shown and comprises an electromagnetic valve 11 on which locked with pipe-connecting portions 13 and valve covers 14 through screws 12. The pipe-connecting portions 13 are connected to airbags, while each of the valve covers 14 is laterally provided with two air-connecting portions 15 that are connected by a linear pipe 16, so that the air intake structure of the electromagnetic valve 11 is arranged in a parallel manner.

The air intake structure of the electromagnetic valve assembly 10 is complicated in structure and the assembly thereof will accordingly not be easy since it is made up of the valve covers 14 fixed to the electromagnetic valve 11 by means of screws 12, and the air-connecting portions 15 of the valve covers 14 must be connected by a linear pipe 16.

The present invention has arisen to mitigate and/or obviate the afore-described disadvantages.

### SUMMARY OF THE INVENTION

The primary objective of the present invention is to provide an air intake structure of an electromagnetic valve assembly for a massage chair, the respective electromagnetic valves are disposed on the air guide bases in a parallel manner, so that the air connecting portions of the respective electromagnetic valves can be inserted in the respective passages at one stroke, simplifying the assembly process more effectively.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 shows a conventional electromagnetic valve assembly for a massage chair;

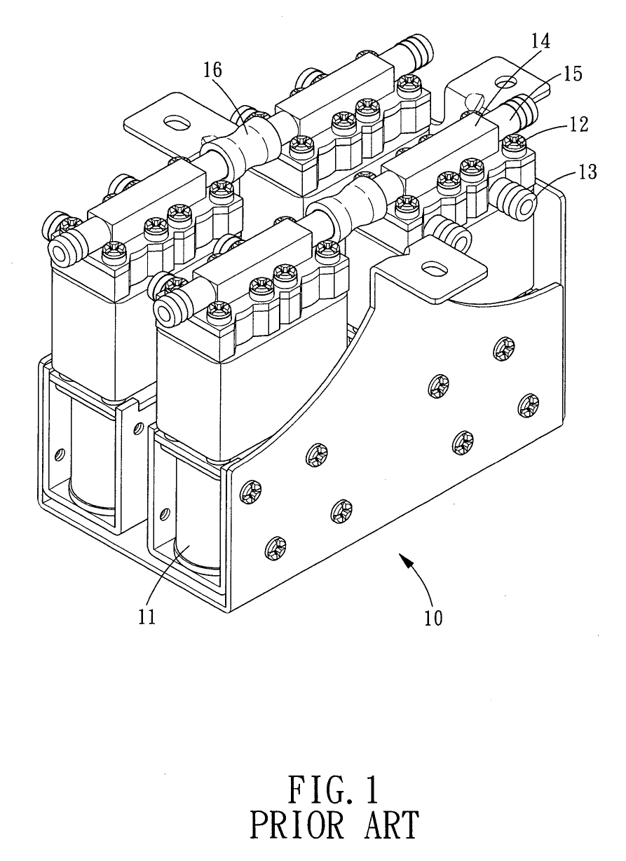

FIG. 2 is an exploded view of an air intake structure of an electromagnetic valve assembly for a massage chair in accordance with an embodiment of the present invention;

FIG. 3 is a cross sectional view of the air intake structure of an electromagnetic valve assembly for a massage chair in accordance with the embodiment of the present invention;

FIG. 4 is an exploded view of an air intake structure of an electromagnetic valve assembly for a massage chair in accordance with another embodiment of the present invention.

### DETAILED DESCRIPTION OF THE PREFERRED EMBODIMENTS

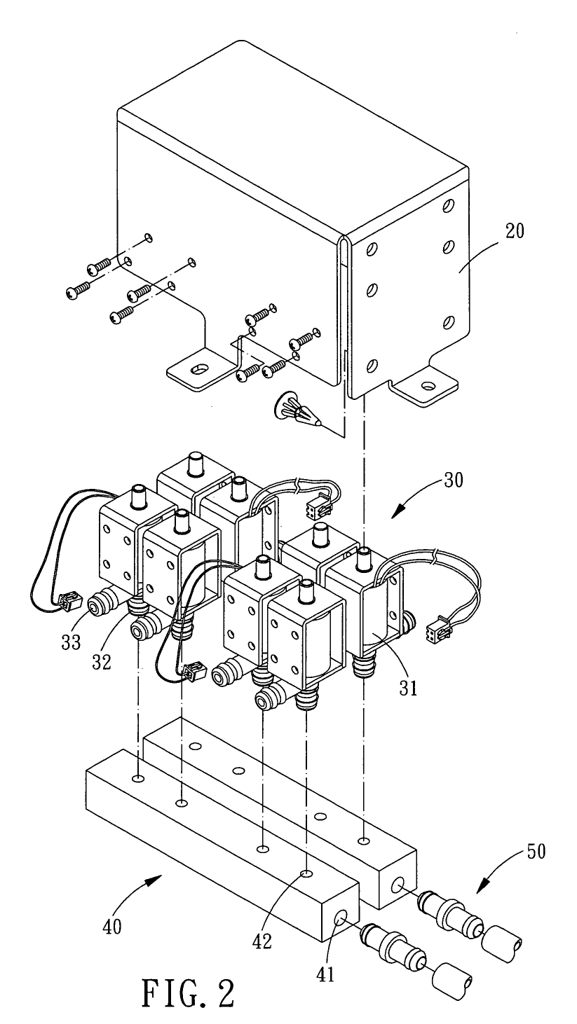

Referring to FIG. 2, an air intake structure of an electromagnetic valve assembly for a massage chair is shown, wherein the electromagnetic valve assembly 30 is disposed in a housing 20 that is fixed at a predetermined position of a massage chair. The air intake structure of the electromagnetic valve assembly includes an electromagnetic valve assembly 30, two air guide bases 40, and an air intake duct assembly 50.

The electromagnetic valve assembly 30 comprises four electromagnetic valves 31, each of the electromagnetic valves 31 is provided with two axial air-connecting portions 32 and two lateral duct-connecting portions 33, and the rest structure of the electromagnetic valves 31 is of known technology, so further remarks will be omitted.

Each of the air guide bases 40 is made of elastic material and is defined at an end thereof with a blind air-feeding hole 41. In the air-feeding hole 41 are laterally defined four passages 42 which are in communication with the air-feeding hole 41 and provided for insertion of the air-connecting portions 32 of the electromagnetic valves 31.

An end of the air intake duct assembly 50 is inserted in the air-feeding hole 41 of the air guide bases 40, and the air intake duct assembly 50 is connected to an air source for introducing air into the air guide bases 40.

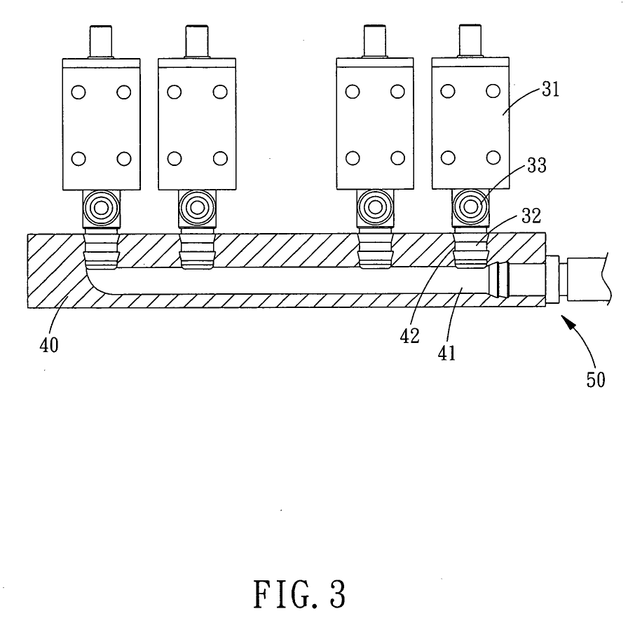

For a better understanding of the present invention, its operation and function, references should be made to FIGS. 2 and 3. Since the air guide base 40 is made of elastic plastic material and the diameter of the passages 42 is smaller than that of the air-connecting portions 32 of the electromagnetic valves 31, ensuring a save locking and air-sealing effect after the air-connecting portions 32 of the electromagnetic valves 31 are inserted in the passages 42. Furthermore, the air intake duct assembly 50 and the air-feeding hole 41 of the air guide bases 40 also have such an air-sealing effect.

When the electromagnetic valves 31 is in operation, air will flow from the air intake duct assembly 50 to the air-feeding hole 41 of the air guide bases 40, and then after passing through the air connecting portions 32 in the passages 42 of the air guide bases 40 and the duct connecting portions 33, the air will finally flow to the airbags to inflate the same.

The respective electromagnetic valves 31 are disposed on the air guide bases 40 in a parallel manner, so that the air connecting portions 32 of the respective electromagnetic valves 31 can be inserted in the respective passages 42 at one stroke, simplifying the assembly process more effectively.

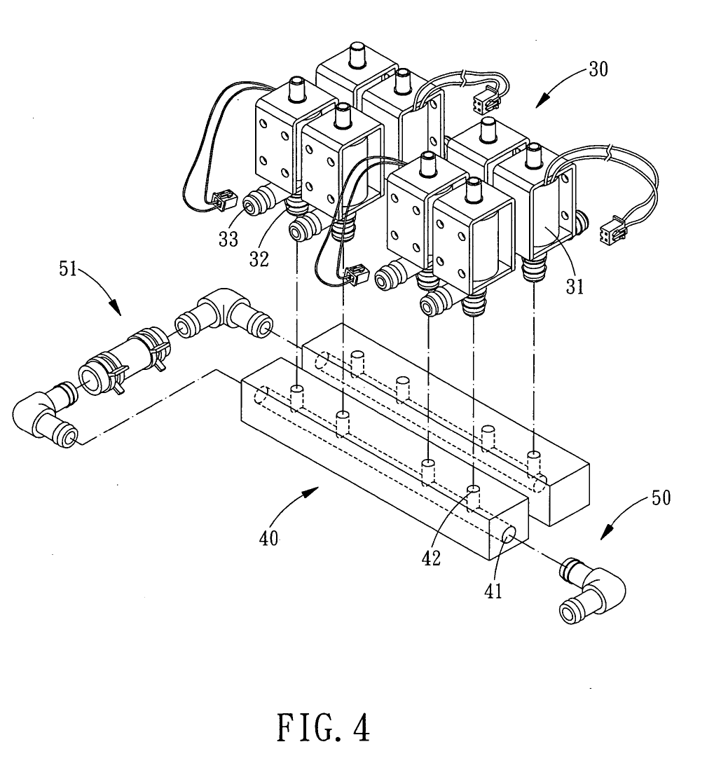

With reference to FIG. 4, an air intake structure of an electromagnetic valve assembly for a massage chair in accordance a second embodiment of the present invention is shown. The air feeding hole 41 of the air guide base 40 also can be a through hole, an end of which is connected to the air intake duct assembly 50 while another end thereof is connected to an air feeding hole 41 of another air guide base 40 by means of a connecting duct assembly 51. In this way, the two air guide bases 40 are arranged in series, and the function and the operation of this embodiment are the same as that of the first embodiment, so further remarks will be omitted.

While we have shown and described various embodiments in accordance with the present invention, it should be clear to those skilled in the art that further embodiments may be made without departing from the scope of the present invention.

1. An air intake structure of an electromagnetic valve assembly for a massage chair comprising a plurality of electromagnetic valves, on each of the electromagnetic valve being defined air connecting portions, wherein an air guide base is made of elastic material and is defined at an end thereof with a blind air feeding hole, in the air feeding hole are laterally defined passages for insertion of the air connecting portions of the respective electromagnetic valves, the air feeding hole is connected with an air intake duct assembly that is connected to an air source for introducing air into the air guide base.

2. The air intake structure of an electromagnetic valve assembly for a massage chair as claimed in claim 1, wherein the air feeding hole of the air guide base is a through hole, an end of the air feeding hole is connected to the air intake duct assembly while another end of the air feeding hole is connected to an air feeding hole of another air guide base by means of a connecting duct assembly, in this way, the two air guide bases are arranged in series.
